(19) United States
(12) Patent Application Publication
(10) Pub. No.: US 2009/0106387 A1
(43) Pub. Date: Apr. 23, 2009

(54) CIDR BASED CACHING AT APPLICATION LAYER

(76) Inventor: Dorai Ashok Shanmugavel Anbalagan, Chennai (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/961,870

(22) Filed: Dec. 20, 2007

(30) Foreign Application Priority Data
Oct. 18, 2007 (IN) 2363/CHE/2007

(51) Int. Cl. G06F 15/16; G06F 15/173

(52) U.S. Cl. 709/217; 709/223

(57) ABSTRACT

A system for CIDR-based caching at the OSI application layer 7 is disclosed. The system improves performance of free peer routing servers, and can be implemented within a video on demand system.

### CROSS-REFERENCE TO FOREIGN APPLICATION

This application claims priority to Indian Patent Application No. 2363/CHE/2007, which was filed in the Indian Patent Office on Oct. 18, 2007, the entire content of which is incorporated herein by this reference thereto and for all purposes as if fully disclosed herein.

### FIELD OF THE INVENTION

The present invention relates to a system for CIDR-based caching. More particularly, the system improves performance of free peer routing servers.

### BACKGROUND

Requesting a high volume of information from the Internet can result in slow response times to the requester. Examples of types of high-volume requests include requests for video, photos or documents with large filesizes. Because of high-volume requests, requests for data over the Internet take longer to service, and sometimes get lost entirely.

As more and more users connect to the Internet, more and more IP addresses are necessary. To avoid having to give every Internet user a distinct IP address relative to all other users of the Internet, classless Internet domain routing (CIDR) was developed. A typical CIDR implementation aggregates a group of users into a subnet, wherein a single IP Internet-side address can in actuality represent thousands of client-side IP addresses.

CIDR is used by many major backbone ISPs. When used by an ISP, all information sent through any Internet-side IP address is sent to the backbone ISP. At the ISP, the information is sorted out according to various criteria and sent to the appropriate client-side IP address.

Within a CIDR implementation, a router uses a bit mask to determine the network and host portions of an address. CIDR implementations thus replace earlier networking categories with a more generalized network prefix. This prefix could be of any length rather than just 8, 16, or 24 bits. This allows CIDR to craft network address spaces according to the size of a particular network, instead of force-fitting networks into pre-sized network address spaces.

In the CIDR model, each piece of routing information is advertised with a bit mask or prefix-length (/x). Routers then use a network-prefix, rather than the first 3 bits of the IP address, to determine the dividing point between the network number and the host number. The prefix-length is a way of specifying the number of leftmost contiguous bits in the network-portion of each entry in the routing table. For example, a network with 20 bits of network-number and 12 bits of host-number would be advertised with a 20 bit prefix (/20). All addresses with a /20 prefix represent the same amount of address space (212 or 4,096 host addresses), that is, 20 bits network+12 bits host.

A typical IP address has 32 bits. One potential size of a subnet can be 11 bits. These 11 bits would comprise the MSB of an IP address. An example subnet could be designated as 71.224.0.0/11. To be within a particular subnet, it is only necessary to match the first 11 bits of an IP address. The rest of the bits are “don't cares”. If a match exists, that means that particular IP address matches the CIDR entry. The shorter the number of significant bits (in this example 11), the larger the number of IP addresses that can be covered. If the number of significant bits is 11, then the number of possible IP addresses within that subnet is 221.

It can be difficult to manage data requests within a network using a CIDR arrangement, because additional address resolution is required. To address this, a CIDR arrangement can also implement a cache to hold routing information of a user. Such a cache is typically located at the network layer (Open Systems Interconnect (OSI) layer 3), because the network layer is where routers typically communicate address information.

However, even when a cache is implemented within a CIDR arrangement, the time for responding to user requests can be lengthy. Consequently, an improved mechanism for managing requests for data is desired.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an example system for managing requests for data, according to an embodiment of the invention;

FIG. 2 is a sequence diagram illustrating various events that may execute within a the system of FIG. 1; and

FIG. 3 shows a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A computer network system utilizes peer routing servers, CIDR, routers, and load balancers to efficiently service user requests for various types of data. The system achieves this partly by using a specialized cache located at an application layer, rather than at a network layer as is typical.

### Explanation of System

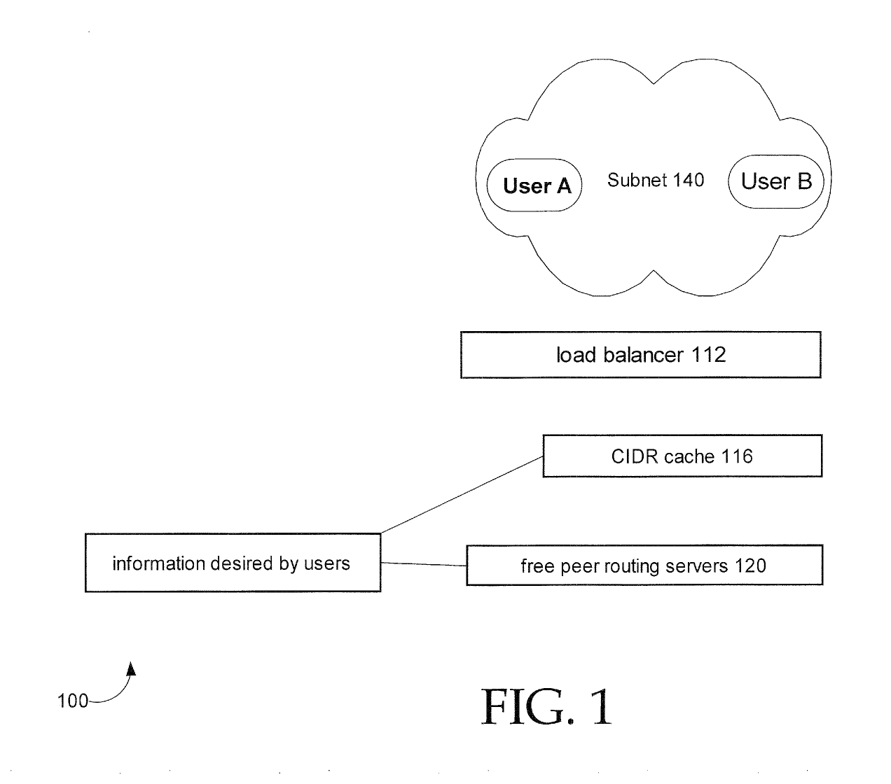

FIG. 1 shows a system 100 in which a CIDR arrangement connects users A and B to peer routing servers 120 through a load balancer 112. Within the system 100, the two example users A and B are located within the same example subnet 140. These users A and B each have their own IP address, and occasionally make requests for data, including but not limited to video streams.

The free peer routing servers 120 are so named for the following reasons. Providers sometimes offer network links to partners. This is known as peering. These network links are usually low cost or free, hence the name “free” “peering” servers. The term routing is added because these servers re-route requests to appropriate datacenters to take advantage of these low cost or free network links.

A request from a user A or B originates in the form of an IP address of a location which contains the desired data. Working with the load balancer 112, the free peer routing servers 120 directs the request for data to a group of co-located streaming servers which hold the data requested by the users. Upon receiving the request for data from a user, the free peer routing servers 120 return a list of co-located servers to the load balancer 112, which then decides which of those co-located servers can service the request at zero or minimal cost for bandwidth.

As stated, within a CIDR implementation, subnet data related to the various users can be held in a cache. Accordingly, the load balancer 112 works with a cache 116 which holds CIDR entries for the various users, of which only A and B are shown in FIG. 1. Referring to the Open System Interconnect (OSI) seven layer model, the cache 116 is located at an application layer (OSI 7), and will thus hereinafter be referred to as a application layer cache 116. Having the cache 116 located at application layer allows content information to be included in the decision-making process.

Where possible, it is desired to have the IP address of the requesting user available within the application layer cache 116, and thus avoid passing the IP address to the free peer routing servers 120. It is desirable to avoid passing the IP address to the free peer routing servers 120 because communicating with the free peer routing servers 120 consumes computing resources and network bandwidth. The application layer cache 116 also holds information regarding co-located servers.

Users A and B can request different video streams or the same video stream. Supposing user B makes a request for data following a request of user A, the system 100 will be able to help user B because both users belong to the same subnet.

The application layer cache 116 holds a CIDR entry associated with a specific user, along with the processed network level information. The system 100 does not incorporate content information into the application layer cache 116 itself. Instead, the system 100 uses the content info in the process of responding to a data request.

### Load Balancer

A load balancer is a device which operates as a type of server, accepts requests for data from Internet users, and routes those requests to a server best suited for servicing the request. Within the system 100, the load balancer 112 assists in deciding which co-located servers will be used to service a user. The data centers housing the co-located servers may have varying levels of available bandwidth. A co-located server with higher available bandwidth means lower cost to the provider. It is therefore desired to store the addresses of the low-cost co-located servers within the application layer cache 116.

The load balancer 112 also resides on the application layer 116, and uses the network layer information within the application layer cache 116 in conjunction with the content information of the converted data to make its decision on which of the streaming co-located servers should service a user's request for data. The load balancer 112 thus identifies a specific co-located server that will be used to service a request for data. In doing so, the load balancer 112 utilizes information like duration, bit rate, and other details related to the requested data.

Referring to FIG. 1, when the user A or B generates a request for data, the free peer routing servers 120 take the IP address of the requested data, and returns a list of co-located servers. The requested data can include but is not limited to low cost video streaming. The free peer routing servers 120 are used by the load balancer 112 for making decisions in how to provide requested data to end users (e.g. users A and B in FIG. 1).

As stated, the load balancer 112 stores the list of co-located servers within the application layer cache 116. However, caching based on IP address alone is ineffective because the free peer routing servers 120 are still hit too often. To address this, the application layer cache 116 also holds CIDR entries for recent users. The application layer cache 116 thus reduces the number of times the load balancing system 112 must hit the servers 120.

Additionally, a cache based on IP address must be 32 bits in width and thus consumes significant amount of memory. Conversely, the application layer cache 116 is the same width as the subnet 140, which is guaranteed to be less than 32 bits, and thus consumes less memory.

The data stored in the application layer cache 116 comprises CIDR entries for recent users, the list of co-located servers, and also bandwidth utilization resulting from processing data contained within the routers. All data associated with the CIDR entry for a specific user is contained within the cache 116. By combining the CIDR entry with other data from the routers, the system 100 then caches the CIDR-based information at the application layer (OSI 7).

Accordingly, when the load balancing system 112 must match an IP address to a list of co-located servers with a specific user, the load balancing system 112 first looks in the application layer cache 116. Since the caching happens not only when a requesting user had visited in the last few minutes, but also when any other user within the subnet 140 had visited, the hit rate of the application layer cache 116 is increased, so that the free peer routing servers 120 are disturbed less often. The hit rate of the application layer cache 116 is based partly on the size of the subnet that the CIDR entry represents, and also on the recent activity of the users within that subnet.

### Application Layer Cache

There is significance to why the cache 116 is located at the application layer (OSI 7) and not at the network layer (OSI 3). At the application layer, the cache 116 can be aware of types of data and the content being streamed or downloaded. Such awareness would not be possible at the network layer (OSI 3). However, locating the cache 116 at application layer (OSI 7) is counter-intuitive, as much of the relevant data used by a typical router is found at the network layer. Thus, it is necessary to efficiently bring the relevant data up from the network layer to the application layer.

Video media is important frontier for Internet providers, but is not well-suited for Internet downloading because of the file sizes as well as the streaming (thus uninterruptible) nature of the video data. The key characteristics of video (duration, resolution, data-density) are contained at the application layer (OSI 7), and not the network layer (OSI 3). Thus, it is useful for the application layer cache 116 to be located at the application layer so as to have access to content (e.g. video) characteristics in making informed routing/CIDR/subnet caching decisions

### Exporting Network Layer Information to Application Layer

There are multiple ways to get information from the routers into a form usable by an application. One way is using a VTY (virtual terminal) interface that many routers provide. To obtain information like the bandwidth usage of a network link, speed of the link, peer IP of the link, it is possible to perform simple network management protocol (SNMP) polling on the routers. This will require formatting the information for use at application layer. Most routers support SNMP so no special equipment is required.

It is also possible to obtain information about a particular routing link by analyzing its data traffic. Doing so requires an arrangement where all the packets passing through the routing link get sent to software which can process these packets and format them application layer use.

Referring to the embodiment shown in FIG. 1, the load balancer 112 resides on the application layer. The load balancer 112 queries the free peering routing servers 120 which in turn read the VTY data from the routers, process the information and provide the processed information to the load balancer 112. The act of querying and reading from a VTY uses code to format the information from the VTY to make it usable by the load balancer 112. The load balancer 112 thus makes use of info both at network layer (e.g. router) as well as application layer (e.g. video data).

### Calculating Bandwidth

Calculating the available bandwidth of a device such as a co-located server can be useful in making routing/CIDR/subnet caching decisions. Total available bandwidth==SUM (speed of network link (i)−bandwidth used in network link (i)), where i==total network links which can reach a particular subnet. The speed of the network link is usually associated to the maximum bandwidth that the link can hold.

The application layer cache 116 is populated with CIDR entries from multiple routers. For example, in a particular arrangement of co-located servers there could be more than one router through which a subnet could be reached. Accordingly, for a particular arrangement of co-located servers, the total bandwidth available on all links through which that subnet could be reached will give the total available bandwidth to reach a particular subnet. The application layer cache 116 will have the CIDR entry associated to total available bandwidth. This calculation of total available bandwidth in a site is an example for the processing of the data from the network layer for use at the application layer.

### Example Uses of System

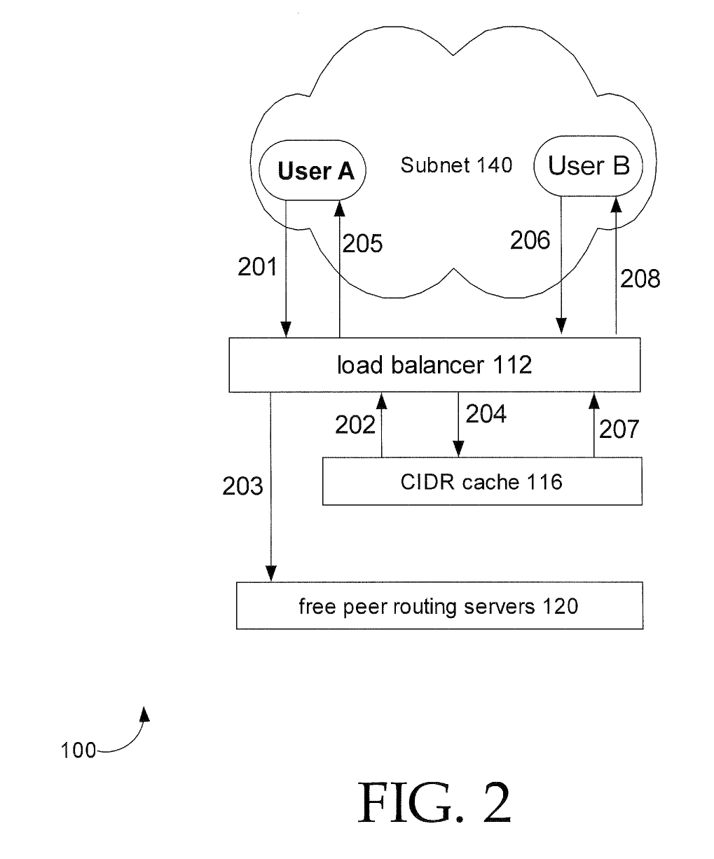

As shown in FIG. 2, an example of the system 100 works as follows. At step 201, the user A makes a request for data (such as but not limited to a video stream) to the load balancing system 112. At step 202, the load balancing system 112 checks the application layer cache 116 for an IP address of one of the numerous co-located servers that can accommodate the user A's request. In this example it will be assumed that there is a miss at the cache 116. At step 203, the load balancing system 112 notes the miss and passes the IP address of the requesting user to the free peer routing servers 120.

At step 204, the load balancing system 112 adds the CIDR information obtained from the free peer routing servers 120 including the IP address of user A, and stores the associated information within the application layer cache 116. Then, at step 205, the load balancing system 112 serves user A with the requested video.

As shown in FIG. 1, user B is located within the same subnet as user A and therefore has the same CIDR information within the application layer cache 116 as user A. At step 206, the user B requests different unrelated data from the load balancing system 112. At step 207, the load balancer 112 checks the CIDR cache 116 for B's IP address. A hit of the application layer cache 116 results because users A and B belong to the same subnet and therefore have the same CIDR entry. At step 208, the load balancing system 112 uses the information from the cache 116 and services user B with the requested data, such as but not limited to a video stream.

Because of the application level cache 116, the number of times the load balancing system 112 needs to pass address info of a user to the free peer routing servers 120 (e.g. step 203) is reduced. Also, the system 100 reduces the average time taken for the load balancer 112 to service a user.

The load balancer 112 can directly look up IP addresses within the cache 116 by relating them to the CIDR entry of a specific user. If the IP address of a user matches a CIDR entry, there is no need to pass the address to the free peer routing servers 120 because the data is contained within the CIDR entry. This, the system 100 reduces address-resolution time, and in turn reduces the time needed to respond to a request by a user.

Having access to content information is also valuable because a user might not come back until a video stream has completed, which might be thirty seconds. Thus, there is no point in caching the IP address of that user, because that user is not going to come back until s/he has watched the video in its entirety, which will be as stated might be at least thirty seconds. To be effective, a cache needs to be updated a lot more often than every thirty seconds. This is because data that may not have value until thirty seconds into the future does not belong in a cache. Instead, by incorporating CIDR/router information into the application layer cache 116, there exists a much higher likelihood of providing relevant, non-stale data. This in turn means the application layer cache 116 will have a higher hit rate.

It is desired to minimize time needed to server user with video stream. In previous embodiments, if the user must do lookups to the free peer routing servers 120, it can be long time before user sees whether their request for data is being serviced or not. During this time the user may not wait, may finally give up, or go elsewhere for the data.

By doing the CIDR entry, if a user from a particular subnet makes a request, that user is cached with all its co-located servers info intact. If another user from the same subnet makes a request, all co-located servers info is already available so that there is no need to access the free peer routing servers 120.

Application level (OSI 7) information associated with a video stream can include the type, format, and bitrate of the video. The term application level includes the application layer (OSI 7), but is not limited just to that. Application level is any layer where user/application data can be associated. By default, routers hold CIDR-cache/routing-table at network layer (OSI 3). The difference between caching at application layer and network layer is that the application layer holds content information about the data being cached.

The system 100 checks available bandwidth, route large jobs to servers with highest available bandwidth, and may route smaller jobs to servers with minimal bandwidth. To illustrate this, suppose it is necessary to service a user requesting significant network resources, the system 100 avoids choking a network link by using a CIDR cache with bandwidth information of those network resources. Now suppose the cache 116 existed in a lower less accessible layer such as the network layer (OSI 3), it would not be possible to pre-determine that the network will get choked, because the network layer does not know anything about video. So the significance of the invention is having the cache at OSI application level 7 rather than a lower OSI level.

Utilization when Users are not in Same Subnet

The subnet 140 of user A and user B in FIG. 1 is intended only to facilitate easier understanding of the invention. However, if user A's IP and user B's IP can match one CIDR entry in the application level cache 116, then the system 100 will still be useful, and it would not matter whether those users are located within the same subnet or not.

For example, user P could belong to 128.10.1.X subnet, where user Q could belong to 128.10.2.X subnet. If the application layer cache 116 holds an entry as 128.10., and a user Q made a request for data after user P, then the system 100 would be helpful. However, if the application layer cache 116 holds an entry 128.10.1., then the system 100 will be less helpful for this particular case. From the above example it is clear that the example requires however that the application layer cache 116 be of a broader size than the requesting subnet. Nonetheless, the CIDR entry that the application layer cache 116 holds is highly dependent on the specific network configuration, but it is possible two users from different subnets could benefit from the system 100.

Video streaming is a beneficiary of the system 100 and has been used as an example for illustrative purposes. However, other high-density data requests also gain an advantage using the system 100.

### Explanation of Slow Startup

Within the system 100, a user requesting data the first time within a subnet will have slow startup because that user won't have an entry in the application layer cache 116. It is necessary to contact a router to get the details for a user's request. This is exacerbated by having to contact 10 or 100 routers within a CIDR arrangement. Accordingly, the slow start is due to the delay in accessing and processing the information from the routing table (CIDRs) in the routers at the network layer.

For these reasons, the system 100 raises the address information contained within the routers to the application layer. However, it is of no value to raise network level information without being able to cache it effectively. Instead, when the system 100 receives a request for data from a user, the system 100 raises the network level information along with the CIDR entry.

### Further Usage Examples

The following example illustrates what happens when a user within the same subnet requests data using the system 100. Suppose a user A at the IP address 44.55.11.23 recently requested data. Now, suppose a user B at the IP address 44.55.11.25 also requests data from the system 100. Assuming a 24-bit subnet such as 44.55.11.0/24, when user A made the request, user A's CIDR entry would get cached along with the used information. Next, when user B visits from IP address 44.55.11.25, the required address information can be obtained from the application layer cache 116 (since the 44.55.11.25 matches 44.55.11.0/24). The system 100 thereby prevents a slow startup for the user B.

To service either user, the load balancer 112 computes information like total bandwidth available, which assists making the decision of which co-located server will serve the user's request for data. For example, suppose a user has requested video data of 30 second duration and 1 Mbps bit rate. The load balancer 112 will then choose the co-located servers with a solid amount of bandwidth available, so that the co-located server with lower bandwidth availability will be spared from absorbing this load.

In another example, suppose a user requests a large file. It is likely that this download is going to use large amount of bandwidth. By knowing the file size (e.g. 200 MB), the system 100 could figure out the ideal datacenter for serving the content based on the bandwidth availability and network status.

In a further example, suppose a co-located server 1 has bandwidth available 50 mbps (50% available), thus its total bandwidth available is 100 mbps. Now suppose a co-located server 2 has bandwidth available 50 mbps (10% available), thus its total bandwidth available is 500 mbps. Now suppose action F has a duration of 30 seconds, and action G has a duration of 300 seconds

From the above it is apparent that both co-located servers 1 and 2 have 50 mbps available, but there are more applications running within server 2 than server 1. Using the bandwidth in server 2 will not be an efficient for serving content with long duration, because there is a possibility of bandwidth starvation of the numerous other applications running therein. Accordingly, for the larger action G, the load balancer 112 would choose co-located server 1. For the smaller action F, the load balancer 112 would choose co-located server 2.

### Hardware Overview

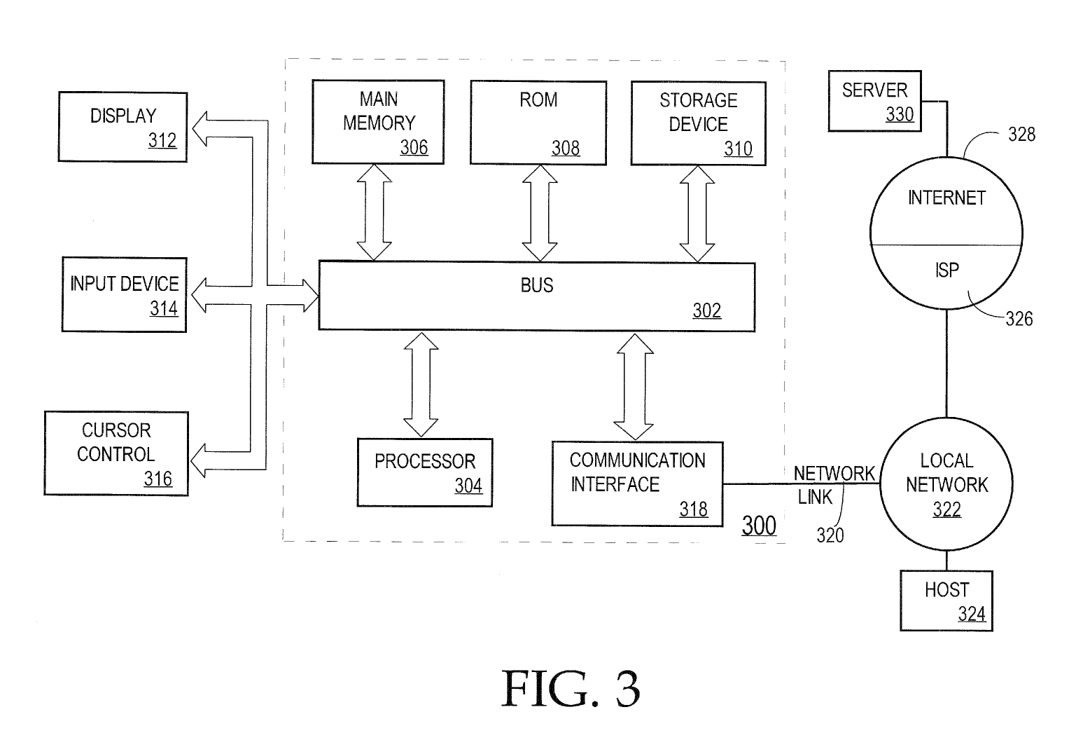

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a machine to operation in a specific fashion. In an embodiment implemented using computer system 300, various computer-readable media are involved, for example, in providing instructions to processor 304 for execution. Such a medium may take many forms, including but not limited to storage media and transmission media. Storage media includes both non-volatile media and volatile media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a computer.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage device 310, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

We claim:

1. A method, comprising:
receiving a first request for first data accessible through a network;
caching first information that (a) is about a subnet associated with a user that submitted the first request, and (b) was obtained in servicing the first request;
receiving a second request for second data accessible through the network;
in response to receiving the second request, obtaining second information that indicates one or more characteristics of the second data requested by the second request;
based on the first data and the second data, determining a manner in which to deliver the second data; and
in response to the second request, delivering the second data;
wherein the step of delivering the second data comprises delivering the second data via the subnet.

2. The method of claim 1, wherein the step of delivering the second data comprises
using both the first data within the cache as well as the second information to perform the delivering.

3. The method of claim 1, wherein the first information is processed network level information.

4. The method of claim 1, wherein the second information is content information.

5. The method of claim 1, wherein the cache is contained within a CIDR mechanism

6. The method of claim 1, wherein the content information is related to video data.

7. The method of claim 1, wherein the content information is related to large file data.

8. The method of claim 1, wherein the second information is stored in a cache.

9. The method of claim 8, wherein the cache is located at an application layer.

10. A system for accommodating a plurality of requests for data over a network, comprising:
a load balancing mechanism, for determining which of a plurality of network servers is best suited to accommodating one of the plurality of requests;
a CIDR cache for storing CIDR entries that correspond to IP addresses of the plurality of network servers;
wherein the CIDR cache is located at an application layer.

11. A computer-readable storage medium storing one or more sequences of instructions which, when executed by one or more processors, causes the one or more processors to perform the method recited in claim 1.

12. A computer-readable medium storing one or more sequences of instructions which, when executed by one or more processors, causes the one or more processors to perform the method recited in claim 2.

13. A computer-readable storage medium storing one or more sequences of instructions which, when executed by one or more processors, causes the one or more processors to perform the method recited in claim 3.

14. A computer-readable storage medium storing one or more sequences of instructions which, when executed by one or more processors, causes the one or more processors to perform the method recited in claim 4.

15. A computer-readable storage medium storing one or more sequences of instructions which, when executed by one or more processors, causes the one or more processors to perform the method recited in claim 5.

16. A computer-readable storage medium storing one or more sequences of instructions which, when executed by one or more processors, causes the one or more processors to perform the method recited in claim 6.

17. A computer-readable storage medium storing one or more sequences of instructions which, when executed by one or more processors, causes the one or more processors to perform the method recited in claim 7.

18. A computer-readable storage medium storing one or more sequences of instructions which, when executed by one or more processors, causes the one or more processors to perform the method recited in claim 8.

19. A computer-readable storage medium storing one or more sequences of instructions which, when executed by one or more processors, causes the one or more processors to perform the method recited in claim 9.
